(19) United States
(12) Patent Application Publication
(10) Pub. No.: US 2006/0049094 A1
(43) Pub. Date: Mar. 9, 2006

(54) Membrane for tangential filtration and production method thereof

(76) Inventor: Philippe Lescoche, Faucon (FR)

Correspondence Address: CLARK & BRODY, 1090 VERMONT AVENUE, NW, SUITE 250, WASHINGTON, DC, 20005, US

(21) Appl. No.: 10/532,560

(22) PCT Filed: Oct. 20, 2003
(86) PCT No.: PCT/FR03/03097

§ 371 Date: Apr. 25, 2005

(30) Foreign Application Priority Data
Oct. 25, 2002 (FR) 0213359

(51) Int. Cl. B01D 63/06

(52) U.S. Cl. 210/321.87; 210/490; 210/497.01; 210/500.25

(57) ABSTRACT

Membrane for the tangential filtration of a fluid, said membrane comprising a porous support (2) delimiting at least one flow channel (3) for the fluid flowing in a given direction (f) between an inlet (6) and an outlet (7), the inner surface (4) of the porous support (2) which delimits channel (3) being coated with at least one separator layer (5) for the fluid, characterized in that the support has variable partial pore-filling (c) extending from the inner surface (4) of support (2) on which the separator layer (5) is deposited, said variable partial pore-filling creating a mean porosity gradient on portion (8) of support (2) of given constant thickness (e) extending from the inner surface (4) of support (2), the minimum mean porosity being located at the inlet (6) and the maximum mean porosity at the outlet (7).

The present invention relates to the technical area of tangential separation using separation elements generally called membranes made from inorganic materials and consisting of a porous support delimiting at least one flow channel for a fluid medium, on whose surface at least one separator layer is deposited whose nature and morphology are adapted to ensure the separation of the molecules or particles contained in the fluid medium to be treated.

The subject of the invention more precisely concerns the fabrication of a porous support.

The subject of the invention finds particularly advantageous application in the area of nanofiltration, ultrafiltration, microfiltration, filtration or reverse osmosis.

Conventionally, a membrane is defined by the association of a porous support in inorganic material, such as ceramic, with one or more separator layers in inorganic material deposited on the surface of each flow channel and bonded to each other and to the support by sintering. These membranes may adopt different geometries. The role of the layers is to ensure the separation of the molecular or particulate species while the role of the support, through its mechanical resistance, is to allow thin layers to be obtained.

In the state of the art, numerous membranes are known made from tubular or flat filtering elements. In the area of tubular membranes, the rigid porous support is of elongated shape having a polygonal or circular cross section. The porous support is arranged to comprise at least one and preferably a series of channels parallel to each other and to the longitudinal axis of the porous support each having a cylindrical shape. On one side the channels communicate with an inlet chamber for the fluid medium to be treated, and on the other side with an outlet chamber. The surface of the channels is coated with at least one separator layer ensuring separation of the molecules or particles contained in the fluid medium flowing inside the channels along a given direction, from one end of the channels called the inlet to the other end or outlet. Through a screening effect said membrane separates the molecular or particulate species of the product to be treated, insofar as all the particles or molecules of greater size than the membrane pores are retained. During separation, transfer of the fluid is made through the separator layer, the fluid then dispersing into the permeability of the support to be directed towards the outer surface of the porous support. That part of the fluid to be treated which has passed through the separation layer and the porous support is called the permeate and is collected in a collection chamber surrounding the membrane.

In the technical area of flat membranes, the porous support is in the form of a block in which at least one and in general a series of superimposed channels is arranged, each having a polygonal cross section that is generally rectangular. The surface of the channels is coated with at least one separator layer.

According to the principle of tangential filtration, the fluid to be treated flows at high speed over the surface of the channels to generate a shearing stress which re-disperses the matter deposited on this surface. This gives rise to fluid friction on the surface of the channels and causes head loss which varies linear fashion in relation to the length of the channels. This head loss is dependent upon dimensional parameters such as the length of the membrane, its hydraulic diameter and on experimental parameters such as flow speed, viscosity and density of the fluid to be treated.

Since the acting filtering force is pressure, there is a decreasing variation in the pressure of the fluid to be treated over the length of the channels. Said pressure gradient modifies the cross flow of the permeate which passes through the separator layer and then the porous body. The flow rate of the permeate therefore varies along the length of the membrane. This flow rate gradient of the permeate leads to heterogeneous separation by the membrane giving rise to different separation schedules along the channels.

In an attempt to overcome these drawbacks, U.S. Pat. No. 4,105,547 describes a cross-flow filter device using a system for compensating head loss. Said system consists of ensuring tangential flow of the permeate on the outside of the membrane, in the same direction as the fluid to be treated flowing tangentially inside the channels. The head loss of the flow of permeate is identical to that of the fluid to be treated. The two losses therefore offset one another so that the pressure remains the same at every point along the channels.

Patent EP 0 333 753 is an improvement on this system. It consists of arranging beads in the permeate compartment to obtain identical head losses to those of the liquid to be treated with a very low flow rate.

Nonetheless, said apparatus has the disadvantage of requiring the use of a permeat recirculation loop which considerably complicates the manufacturing process and increases energy costs related the operation of this additional loop.

To remedy these disadvantages, patent EP 0 870 534 B1 proposes a macroporous support whose external porosity is modified to provide a porosity gradient along the length of this support. This porosity gradient gives rise to a permeability gradient. On account of the variation in pressure, the flow rate of the permeate passing through the membrane becomes constant. While this solution makes it possible to modify solely the support, this technique has the drawback of reducing the external porosity of the support thereby facilitating the build-up of molecules or particles which have passed through the separator layer and which, statistically, may be retained by that part of the support having reduced porosity. In practice, the diameter of the pores over the straight cross section of such a support increases and then decreases at its periphery, so that there is a risk of build-up of molecules or particles. Said build-up may lead to destruction of the support. Also, porosity is reduced solely on the outer ring of the porous support. Therefore the porosity of the support, in its inner part adjacent to the separator layer, is not reduced. During the separating operation therefore the pressure inside the channels decreases in the direction of flow of the fluid to be treated. The permeate, after passing through the separator layer, disperses within the inner porosity and flows outwards seeking an area that requires less energy. The permeate therefore flows chiefly via that part of the support that is most porous. Under these conditions, the porosity gradient obtained leads to the onset of heterogeneous flow rates of permeate along the length of the membrane.

Patent application EP 1 074 291 proposes a solution enabling a homogeneous permeate flow rate to be obtained along the length of the membrane. This solution consists of depositing, on the macroporous support, a separation layer having a thickness gradient that decreases in the direction of flow of the fluid to be treated. In this case, the support ensures mechanical strength without taking part in the hydraulic resistance of the membrane, while the separator layer defines permeability without taking part in mechanical strength.

The invention therefore sets out to propose another solution with which to overcome the afore-mentioned disadvantages, by proposing a tangential filtration membrane adapted to obtain a more homogeneous permeate flow along the length of the membrane and which does not have any weak area in which species of the fluid to be treated may build up and be retained by the membrane. The solution put forward by the invention consists of modifying the porous support on its part adjacent to the separator layer to cause it to participate in membrane permeability.

To achieve this objective, the membrane of the invention for tangential filtration of a fluid to be treated comprises a porous support delimiting at least one flow channel for the fluid to be treated flowing in a given direction between an inlet and an outlet, the inner surface of the porous support which delimits the channel being coated with at least one separation layer for the fluid to be treated, a fraction called a permeate passing through the separator layer and the porous support. The support has variable partial pore-filling extending from the inner surface of the support on which the separator layer is deposited. Said partial pore-filling, on a portion of the support of given constant thickness extending from the inner surface of the support, creates a mean porosity gradient in the direction of flow of the fluid to be treated, the minimum mean porosity being located at the inlet and the maximum mean porosity at the outlet.

A further objective of the invention is to propose a method for producing a tangential filtration membrane for a fluid. According to the invention, said method comprises a step consisting of modifying the porous support by the penetration, from the inner surface of the porous support delimiting the flow channel, of inorganic particles whose mean diameter is less than the mean pore diameter dp of the support so that, over a portion of given constant thickness extending from the inner surface of the support, a mean porosity gradient is obtained in the direction of flow of the fluid to be treated, the minimum mean porosity being located at the inlet and the maximum mean porosity at the outlet.

Various other characteristics will become apparent from the following description with reference to the appended drawings which give non-restrictive examples of forms of embodiment and implementation of the subject of the invention.

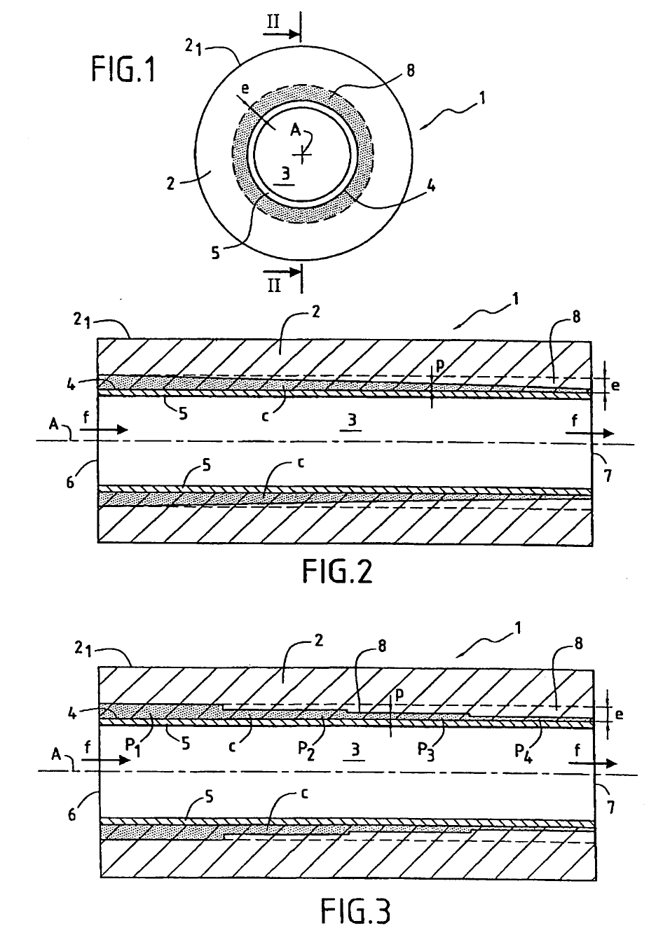

FIG. 1 is a cross-section view of an example of embodiment of a membrane according to the invention.

FIG. 2 is a longitudinal section view of a membrane viewed substantially along lines II-II in FIG. 1.

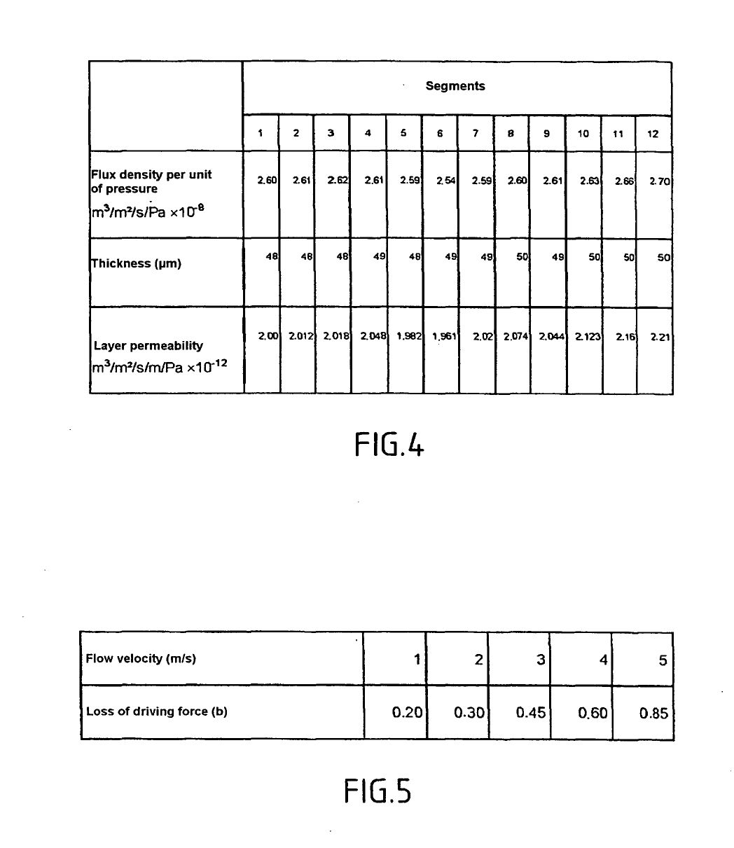

FIG. 3 is a similar view to FIG. 2 illustrating another variant of a membrane according to the invention.

FIGS. 4 to 16 are tables giving experimental measurements for a prior art membrane and for membranes of the invention respectively.

Before describing the invention, a certain number of definitions need to be given.

Porosity designates the volume of the support pores with respect to the total apparent volume of the support. Porosity is measured for example using a mercury porometer. This is an apparatus which sends mercury under pressure into a porous sample. This apparatus gives the distribution of pore diameters but also the porosity of the porous body.

The existence of a mean porosity gradient on a volume portion of given constant thickness means that, if this portion of constant thickness is divided into a series of equal elementary volumes corresponding to segments extending transversely in relation to the longitudinal axis of the section, the mean porosity of these elementary volumes varies as one moves along the longitudinal axis of this section.

Flux density per unit of pressure and the permeability of a porous support translate the ease with which a fluid medium can pass through said support. Flux density, in the meaning of the invention, designates the quantity of permeate in m³ passing through the surface unit (in m²) of the support per unit of time (in s). Flux density per unit of pressure is therefore measured in m³/m²/s/Pa×10⁻¹².

Permeability, in the meaning of the invention, corresponds to flux density per unit of pressure in relation to thickness and is expressed in m³/m² /s/m/Pa×10⁻¹².

As shown FIGS. 1 and 2, the filtration membrane 1 of the invention is adapted to ensure the separation or filtration of molecules or particles contained in a fluid medium, preferably liquid, of various types whether or not comprising a solid phase. In the illustrated example of embodiment, the geometry of the filtration membrane 1 is of tubular type. According to this example, the filtration membrane 1 comprises a rigid inorganic porous support 2 made in a material whose transfer resistance is adapted to the separation to be carried out. The porous support 2 is made from inorganic materials such as metal oxides, carbon or metals. In this example of embodiment, the porous support 2 is made in elongated form extending along a longitudinal central axis A. The porous support 2 has a polygonal cross section or, as in the example illustrated FIGS. 1 and 2, a circular cross section. The porous support 2 therefore has a cylindrical outer surface 2₁ of circular cross section.

The porous support 2 is arranged to comprise, in the illustrated example, at least one channel 3 made parallel to axis A of the support. In the illustrated example, the cross section of the channel transversal to axis A of the support, is of cylindrical shape. The channel 3 has an inner surface 4 coated with at least one separator layer 5, intended to be in contact with the fluid medium to be treated, flowing inside channel 3 in a flow direction indicated by arrows f making it possible to determine an inlet 6 and an outlet 7 for said membrane operating in tangential mode. The type of separator layer(s) 5 is chosen in relation to the separating or filtering power to be obtained and, with porous support 2, forms a close bond so that the pressure derived from the liquid medium is transmitted to the porous support 2. This or these layers may be deposited from suspensions, for example containing at least one metal oxide conventionally used in the production of mineral filtering elements. This or these layers, after drying, undergo sintering to consolidate them and bind them together and to the porous support 2. Part of the liquid medium passes through the separator layer 5 and the porous support 2, so that this treated part of the fluid, called permeate, can flow via the outer surface 2₁ of the porous support.

According to the invention, that part of the support 2 adjacent to the separator layer 5 is modified with respect to the remainder of the support. In the vicinity of the separator layer 5, the support 2 has variable partial pore-filling which extends along the support from the inner surface 4 of support 2 on which the separator layer 5 is deposited. This pore-filling is said to be <<partial>>, since the support is not entirely filled as it allows the permeate to pass through. This partial pore-filling is said to be <<variable>> as it varies along the length of the support 2 and thereby, over portion 8 of given constant thickness e extending from the inner surface 4 of support 2, creates a mean porosity gradient in the direction of flow f of the fluid to be treated. That part of portion 8 that is most filled and has the lowest mean porosity is located at the inlet 6 of the membrane, while the part that is least filled having the highest mean porosity is located at the outlet 7 of the membrane. Therefore, the flux density per unit of pressure increases along support 2, between the inlet 6 and outlet 7. Hence, the flow rate of the permeate passing through the separator layer 5 and the porous support 2 is constant along the length of the membrane, insofar as the mean porosity gradient and hence the flux density gradient per unit of pressure vary in a manner that is inversely proportional to the pressure exerted by the fluid medium to be separated. The pressure of the fluid to be treated decreases in the direction of flow f of the fluid, namely from inlet 6 to outlet 7 of the membrane. The flux density gradient of the layer per unit of pressure is therefore chosen so as to obtain a constant permeate flow rate over the entire length of the membrane.

In addition, the invention offers a further advantage. Inside the support described in patent EP 0 870 534 B1, the mean diameter of the pores increases then decreases over a direction transverse to the direction of flow of the fluid, from the separator layer towards the outer surface of the support, thereby promoting build-up zones. On the contrary, in the invention, the mean porosity of the support increases inside support 2, and in particular inside portion 8, over a direction transverse to the direction of flow f of the fluid to be treated, i.e. from the inner surface 4 of the support 2 towards its outer surface 2₁.

The mean porosity gradient is obtained by the penetration, from inner surface 4 of support 2, of particles whose mean diameter is less than the mean pore diameter of the support 2, which makes it possible to obtain partial pore-filling c of portion 8 of the support 2. This portion 8 extends from the inner surface 4 of support 2 intended to receive the separator layer 5. Portion 8 is a volume portion of constant thickness e. As shown FIG. 2, thickness e corresponds to the maximum depth of partial pore-filling c, a depth determined from the inner surface 4 of the support 2 on which the separator layer 5 is deposited. This partial pore-filling c corresponding to the penetration of particles is made over a depth p which depends upon particle size, i.e. particle diameter, and experimental penetration conditions. In general, penetration depth p does not exceed a few dozen μm, the value reached by the finest particles.

The existence of a mean porosity gradient on portion 8 of constant thickness e means that, if this portion 8 is divided into a series of equal elementary volumes corresponding to segments extending transversely with respect to the direction f of fluid flow, the mean porosity obtained for these elementary volumes increases in longitudinal direction in the direction of flow f of the fluid to be treated.

The existence of a mean porosity gradient which increases at portion 8 defined above translates as the existence of a flux density gradient per unit of pressure which increases along the length of support 2.

The presence of particles inside support porosity may have two effects:
the first relates to a decrease in support porosity,
the second to a decrease in mean pore diameter of the support.

These two effects each have the consequence of reducing the flux density of the support per unit of pressure.

To obtain a flux density gradient per unit of pressure along the length of support 2, between the inlet 6 of the membrane operating in tangential mode and its outlet 7, the invention provides for variation of:
either the penetration depth p of the particles along the membrane. In this case, the particles used all have the same mean diameter, the variation in penetration depth p being acquired by modifying the depositing parameters,
or the porosity and mean pore diameter of the support after penetration. In this case, particles of different particle size are used, penetration of the finest particles following after penetration of the largest particles,
or by combining the two above methods.

According to a first variant of the invention, mean porosity may increase in substantially continuous manner over portion 8 of constant thickness e between inlet 6 and outlet 7. In this case, the flux density per unit of pressure also increases in substantially continuous manner between inlet 6 and outlet 7.

As can be seen more clearly in the example illustrated FIG. 2, this mean porosity gradient may be obtained by causing particles to penetrate from the inner surface 4 of the support over a depth p which decreases in substantially continuous manner in the direction of flow f of the fluid to be treated. It is to be noted that in the figures the size ratio between the separator layer 5, section 8 and porous support 2 is not observed: the separator layer 5 and section 8 are represented on larger scales in order to illustrate the subject of the invention.

According to another variant, the mean porosity on portion 8 of support 2 of constant thickness e, may increase in plateaus Pᵢ. In this case, the flux density per unit of pressure also increases in plateaus Pᵢ between inlet 6 and outlet 7.

If the increase occurs in plateaus, the length of the segments taken along the direction of flow f corresponding to the elementary volume for measuring mean porosity and flux density per unit of pressure, corresponds to the length of plateaus Pᵢ. FIG. 3 illustrates the case when this mean porosity gradient is due to partial pore-filling c, corresponding to particle penetration over a depth gradient p. Depth p decreases in plateaus Pᵢ, in the direction f of flow of the fluid to be treated, between inlet 6 and outlet 7. In the illustrated example, there are four plateaus P₁ to P₄ corresponding to four penetration depths p. Penetration depth p on plateau P₁ located at inlet 6 is greater than the penetration depth of the next plateau P₂ and so on for the other consecutive stages. In the illustrated example, penetration depth p is constant for each plateau. Provision could also be made for the penetration depth p to decrease progressively on each plateau in the direction of flow f, with a change in depth at the junction between two consecutive plateaus. Said plateaus are preferably of substantially identical length taken in the direction of flow.

It is to be noted that above-described examples concern a single channel membrane comprising a channel of cylindrical shape having a substantially ovoid cross section. Evidently the subject of the invention may be applied to membranes comprising one or more channels of varied, diverse forms. Similarly, the subject of the invention may evidently be applied to a membrane comprising at least one channel 3 of polygonal cross section, arranged in a porous block to form a flat-type membrane. In this type of membrane, the porous support 2 comprises a series of superimposed channels 3 each having a rectangular cross section and whose walls are coated with a separator layer 5. For membranes with several channels, the support undergoes partial pore-filling, such as defined above, in the vicinity of each inner surface 4 delimiting a channel 3. The support therefore has modified porosity, over the volume adjacent to the inner surface 4, a volume located either between a channel 3 and the outer surface 2₁ of the support, or between two channels 3.

The subject of the invention also concerns a production method for a filtration membrane 1 such as described above. Said method comprises a step consisting of modifying the porous support 2 by the penetration of inorganic particles, from inner surface 4 of said support, having a smaller mean diameter than the mean pore diameter dp of the support 2. This penetration is made so that, on portion 8 of constant thickness e, a mean porosity gradient is obtained in the direction of flow of the fluid to be treated, the minimum mean porosity being located at the inlet and the maximum mean porosity at the outlet.

By smaller mean diameter than the mean pore diameter dp of the support 2, is preferably meant that the mean diameter of the inorganic particles lies between dp/100 and dp/2.

Penetration of the particles inside support 2 is achieved using a deflocculated suspension of said particles. Deflocculating of the suspension is necessary to avoid the formation of particle clusters and hence to maintain the particles in separated form able to penetrate inside the pores of the support. Advantageously the suspension has low viscosity.

Said particles consist of an inorganic material such as metal oxides, the constituent inorganic material of the inorganic particles possibly being identical to the material used for the support and/or separator layer 5.

The penetration step is followed by a sintering step to bind together the particles present in the pores of the solid support 2 leading to enlargement and amalgamation of said particles to fix the partial pore filling of the solid support 2. To obtain variable, partial pore-filling c creating a mean porosity gradient in the direction of flow of the fluid to be treated, the minimum mean porosity being located at the outlet and the maximum mean porosity at the outlet, variable penetration of the inorganic particles is required within portion 8 of the porous support.

The following description relates to a production method for a membrane such as illustrated FIG. 2. In this case, the penetration of particles of same particle size is made inside the pores of portion 8 over a depth p measured from the inner surface 4 of support 2 which decreases in the direction of flow f of the fluid to be treated. Said variable penetration in relation to the length of the support may be made using a contact method which consists of arranging the porous support 2 vertically and filling the channel 3 with a deflocculated suspension of inorganic particles whose mean diameter is less than the mean pore diameter dp of the support using a pump of peristaltic type at variable rotating speed. The channel filling time is denoted Tr. The time during which the support is maintained filled with the suspension by acting on the rotation speed of the pump is denoted Ta. The support is then emptied by reversing the direction of rotation of the pump, the emptying time being denoted Tv. The three times Tr, Ta, Tv define the contact time Tc between each point of the inner surface 4 of support 2 and the suspension.

At a point x of the inner surface 4 of support 2 located at a height h, the contact time Tc with the suspension is:
Tc=(Tr+Ta+Tv)−Ss/Qpr*h−Ss/Qpv*h (I)

in which:

Tr=filling time

Ta=waiting time full tube

Tv=emptying time

Tc=contact time

Qpr=pump flow rate during filling

Qpv=pump flow rate during emptying

Ss=section of channels

h=filling level

Penetration depth p of the particles inside the support depends upon the contact time Tc between the porous support 2 and the suspension. Therefore, provision is made to empty channels 3 progressively, in order to obtain a contact time Tc between the suspension of particles and the support 2 which increases progressively and in substantially continuous manner between the top of the support corresponding to the outlet 7 and the bottom of the support corresponding to the inlet 6. It is also possible to obtain a penetration depth p which increases from the top end to the bottom end of the support. Therefore, by using different values for the contact time Tc, by acting on Tr, Ta and Tv in accordance with equation (I), it is possible to choose the mass of inorganic particles penetrating inside the support 2.

To manufacture a membrane such as illustrated FIG. 3, one method may consist of dividing channel 3 into a series of segments Pᵢ of substantially equal length, for example totalling four P₁ to P₄ in the illustrated example. The surface of the channel 3 is contacted with a deflocculated suspension of particles of smaller mean diameter than the mean pore diameter dp of the support. In conventional well-known manner, penetration depth p is controlled by parameters of suspension concentration and contact time between the suspension and the porous support 2. For one same suspension, the contact time is reduced from plateau P₄ to plateau P₁.

Another technique with which it is possible to achieve variable, partial pore-filling c is to conduct successive penetrations of inorganic particles having different mean diameters, these diameters to be smaller than the mean pore diameter of the support at all times. In particular, two successive penetrations may be made, the first using inorganic particles of mean diameter d₁ lying between dp/100 and dp/2, then a second with inorganic particles whose mean diameter d₂ lies between d₁/100 and d₁/2.

Evidently, the fabrication of a porous support comprising variable partial pore-filling extending from the inner surface 4 may be made using methods other than those described above. By choosing the extent of partial pore-filling and hence the value of the mean porosity and flux density gradients per unit of pressure in portion 8 in relation to the pressure gradient of the fluid to be treated flowing in channel 3, it is possible to obtain a substantially constant permeate flow rate along flow channel 3.

Also, according to another aspect of the invention, provision may be made to use inorganic particles for partial pore-filling that are identical in size and composition to those used for fabricating the separator layer 5. In this case, the invention provides for a deposit to be made on the inner surface 4 of this support during the particle penetrating operation. Under these conditions, the partial pore-filling of the support and depositing of the separator layer 5 are conducted simultaneously. In this case, the thickness of separator layer 5 may decrease in the direction of flow f of the fluid to be treated, as described in EP 1 074 291.

On the other hand, if the particles used for partial pore-filling are different to those used for fabricating the separator layers, the invention provides for avoiding the formation of a deposit on the inner surface 4 of the porous support 2, at the time of penetration of inorganic particles inside support 2.

In the following examples, a single channel support of outer diameter 10 mm, inner diameter 6 mm and length 1200 mm is used. This porous support has a mean equivalent pore diameter of 5 μm.

On the walls of the channel, firstly a suspension of titanium oxide is deposited which, after sintering, leads to obtaining a mean equivalent diameter for this deposit of 1.5 μm.

To analyse the homogeneity of the deposit, the membrane so fabricated is cut into 12 segments of length 10 cm, which are measured for water permeability. This membrane was made as a control membrane with no partial pore-filling.

The table in FIG. 4 using water as fluid, shows:
the flux density per unit of pressure measured for each segment,
the thickness of the layer with mean equivalent pore diameter of 1.5 μm,
the permeability of the layer determined using a flux density value for the support per unit of pressure of 6.9×10⁻⁸.

The values given in this table show that the segments are relatively homogeneous regarding flux density, layer thickness and hence permeability.

The head losses of the fluid flowing inside a membrane such as above having a length of 1178 mm in relation to the flow rate are given in the table in FIG. 5.

By way of reference, the flow rates of the filtrate of this membrane in relation to the sampling position on the membrane are also given. These measurements are made with an apparatus consisting of a TAMI CéRAM Inside casing ref CLC120100100 segmented into four equal parts. On each of these parts are arranged:
permeate outlets in the vicinity of each end,
DN 38 clamp connectors at the inlets/outlets available for each segment.

The gaskets used to seal the clamp connectors are special in that they comprise a hole of diameter 9.5 mm in their centre. The four casings are joined together via their special gaskets.

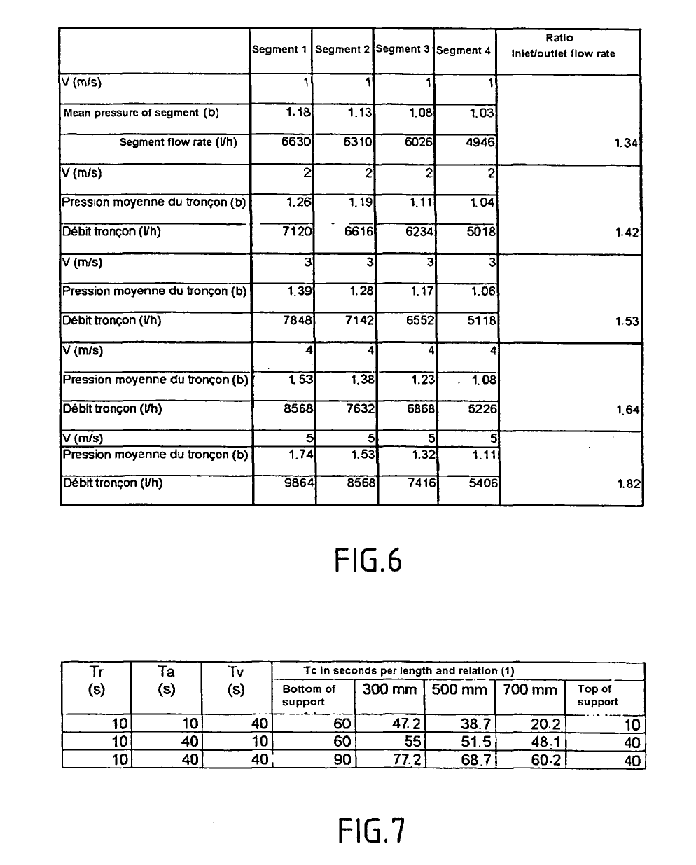

The membrane 1178 mm long is arranged inside these four casings, and the assembly is then connected to a pump supplying flow rates of between 100 and 500 l/h corresponding to respective speeds of 1 and 5 m/s. Under these conditions, and by means of the permeate outlets on each casing, the flow rates of the permeate are measured for each of the casings. The table in FIG. 6 defines the experimental conditions and gives the filtrate flow rate values obtained.

It appears that, irrespective of flow velocity, the flow rate of the segment depends upon pressure value. This is the consequence of the head loss undergone by the flow of fluid inside the membrane. The ratio between the flow rate of the inlet segment and the flow rate of the outlet segment increases with flow velocity to reach the value of 1.82 at a velocity of 5 m/s.

The following description is intended to provide three examples of embodiment of the membrane of the invention.

### Example of Embodiment 1 of the Invention

This example corresponds to the penetration inside support 2 of a suspension of particles which may also be used to form a separator layer 5.

A suspension of titanium oxide particles of particle size 0.5 μm is prepared. This suspension is deflocculated using a specific agent called COATEX which separates the particles from one other and eliminates any sedimentation. No organic binder is added to obtain very low viscosity.

Single channel supports of outer diameter 10 mm, inner diameter 6 mm and length 1200 mm are used. These porous supports have a mean equivalent pore diameter of 5 μm and they are identical to the one used previously as reference. These supports are then subjected to the above-described penetration operation. Values Tr, Ta and Tv used are given in the table in FIG. 7. For each trio of values Tr/Ta/Tv, two supports are modified by penetration of the suspension then, after drying, are calcined at a temperature in the order of 1100° C. These supports so modified are defined by their trio of Tr/Ta/Tv, values, i.e. for example 10/10/40.

The first modified support in each series is measured for water permeability with the casing used above. A single speed (5 m/s) is used for these measurements.

The second modified support is cut up so as to take samples in the form of thin segments (2 to 3 mm in height) at lengths of 0 mm, 300 mm, 500 mm, 700 mm and 1178 mm. These segments are intended to measure penetration inside the support and the thickness of the deposit on the inner surface 4 of the support, if said deposit exists.

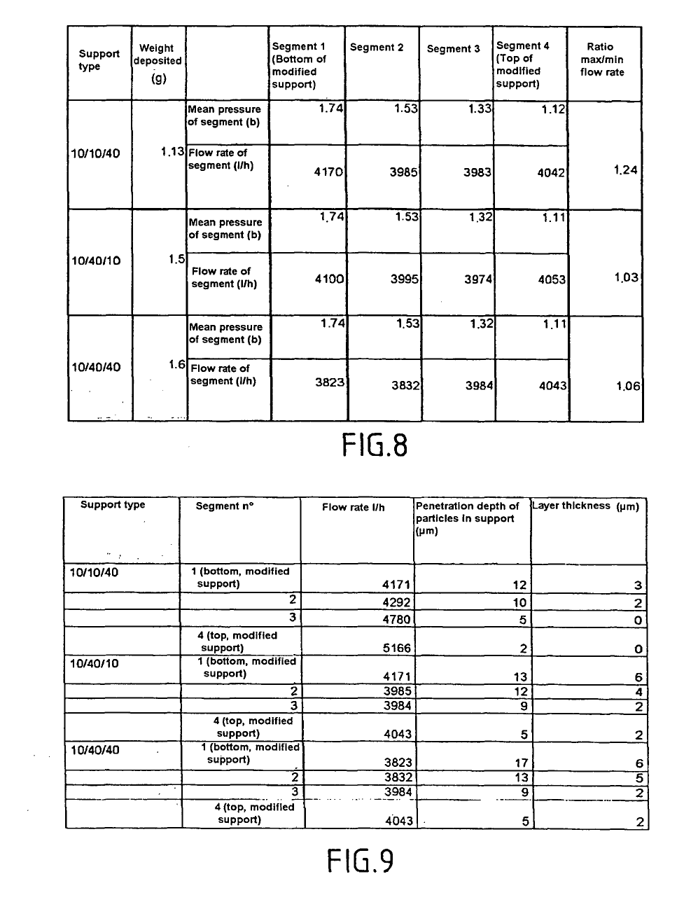

The table in FIG. 8 gives the flow rate values of the segments.

The segments are numbered from 1 to 4, n° 1 corresponding to the bottom part of the support during the penetration operation. These results show that, for the membranes of the invention, with respect to the above reference membrane, the flow rate per segment has become considerably uniform in relation to segment order. These results are the direct consequence of the flux density gradient per unit of pressure which offsets the pressure gradient existing along the length of the channel.

Measurements of the penetration of particles inside the porosity of the support were made on segments of narrow thickness sampled at lengths 0 mm, 300 mm, 700 mm and 1178 mm. These segments of narrow thickness were filled with coating resin then polished to observe particle penetration, on a single plane, using an electronic scanning microscope.

The table in FIG. 9 gives the measurements of particle penetration in the support and the thickness of the layers. Examination of this table leads to ascertaining that the particles effectively penetrated inside the porosity of the support from its inner surface 4 and that the depth of penetration is indeed the consequence of the contact time with the suspension. As indicated previously, the contact time at a point of the support is dependent upon the height of this point. The results show that the depth of penetration varies similarly to this contact time and that a penetration depth gradient is thereby obtained and hence a flux density gradient per unit of pressure and a porosity gradient which promote the homogeneity of permeate flow rates.

When penetration depth becomes extensive, the particles can no longer advance inside the support. The support can be considered as partially filled. But, since capillary aspiration is maintained, the particles continue to arrive at the surface of the support and form a deposit. This is shown by the thickness values of the layer corresponding to this deposit which are zero when contact time is short, then become positive and even substantial with longer contact times. The deposit may correspond to the separator layer 5 of the membrane.

### Example of Embodiment 2 of the Invention

In this example, the inorganic particles used for the penetration step cannot be used to form a separator layer 5. In this case, the invention avoids the formation of a deposit.

Single channel supports of outer diameter 10 mm, inner diameter 6 mm and length 1200 mm are used. These porous supports have a mean equivalent pore diameter of 5 μm and they are identical to the one used previously as reference.

The inorganic particles used are titanium oxide particles having a mean particle diameter of 1 μm. This diameter is obtained after vigorous grinding in a jar containing alumina pellets 5 mm in diameter. These particles are deflocculated using an additive of the COATEX family. The suspension does not contain any organic binder and particle concentration is less than 50 g/l. The values of these two parameters are intended to obtain very low viscosity.

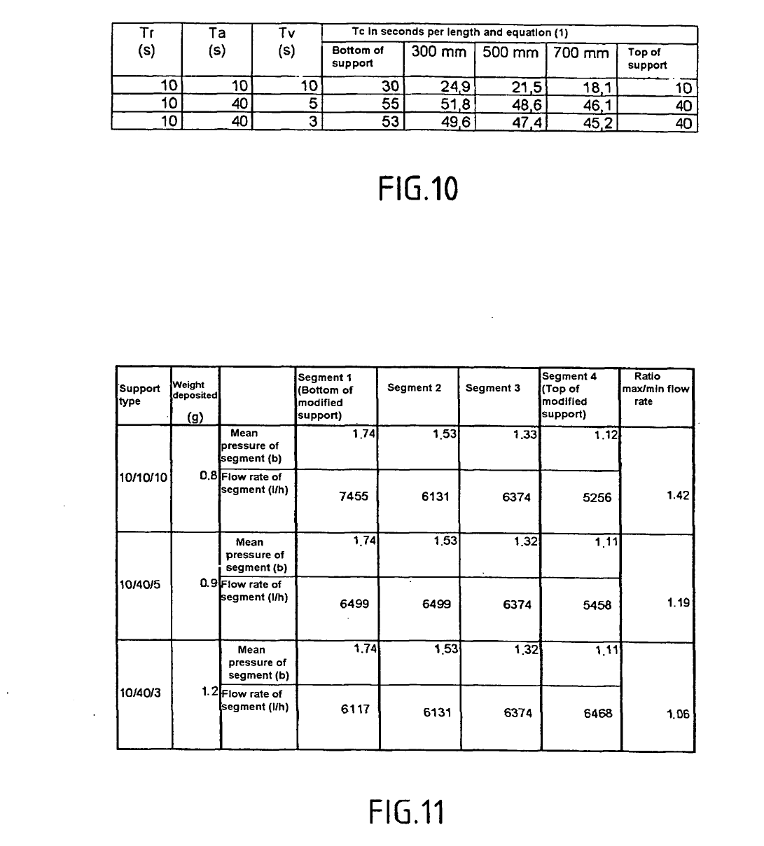

The supports are modified by particle penetration using this suspension and under the experimental depositing conditions defined in the table in FIG. 10.

In this series of particle penetration inside support 2, the emptying rate was significantly increased to obtain a shearing stress at the wall of the membrane and thereby to erode any deposit which may have formed. The three emptying times 10 s, 5 s and 3 s respectively correspond to speeds of 0.117 m/s, 0.234 m/s and 0.39 m/s.

Three supports were made for each trio Tr/Ta/Tv. These modified supports were calcined at 1100° C., then two of them underwent the same sampling and measurements as in the example of embodiment n° 1 above, the third being intended to receive depositing of a separator layer 5 for its transformation into a membrane.

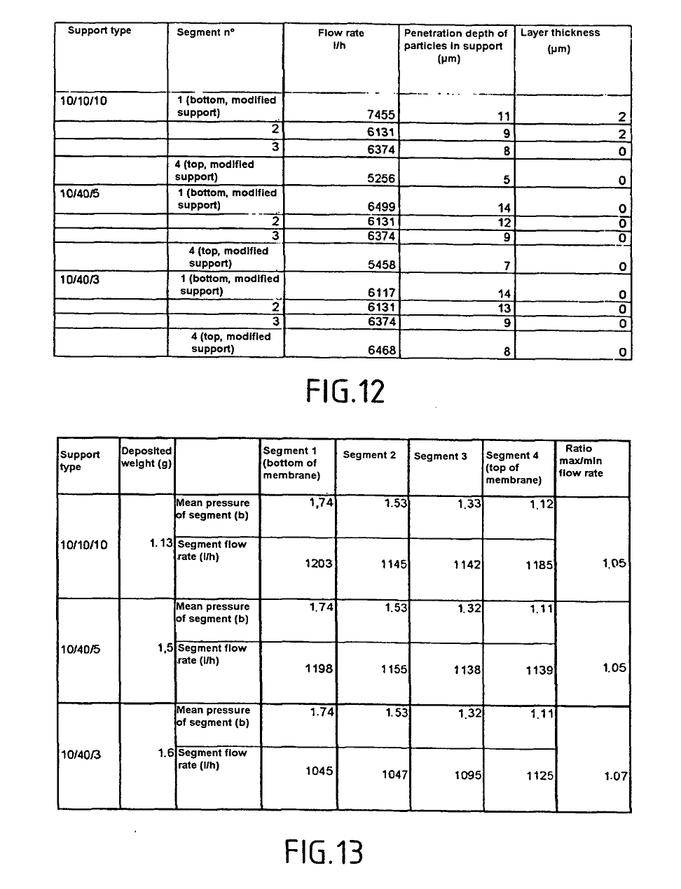

The table in FIG. 11 gives the flow rate values measured on these modified supports. The flow rate values obtained with this method are less homogeneous than with the preceding method but remain far better than those of the reference support. The emptying rate improves the homogeneity of the flow rates and therefore represents an important parameter. The depths of the different penetrations and the deposit thicknesses, when they exist, were determined using the previous method. The table in FIG. 12 gives the results obtained. This table shows that the penetration of 1 μm particles is less extensive than in the preceding example using particles of 0.5 μm. Irrespective of the type of modified support, the penetration at the bottom part of the support is always greater than in the upper part, thereby creating a porosity gradient and hence a flux density gradient per unit of pressure which promotes the obtaining of homogeneous flow rates.

On the third modified support, a separator layer having a mean pore diameter of 0.2 μm was deposited.

After depositing, drying and sintering, the results obtained with the casing used for measuring the support per segment are given in FIG. 13. Throughout these measurements, the flow rate was 5 m/s. The homogeneity observed on these modified supports is found on the membrane. This result is normal since the deposit which forms the membrane is very regular, which corresponds to adding to each modified support segment a hydraulic resistance or permeability that is substantially identical.

### Example of Embodiment 3 of the Invention

In this example, two particle powders of different mean diameter are used. Two suspensions of these two powders are contacted with the support one after the other so as to increase the partial pore-filling of the support without causing a deposit to form on the surface of the channels. The particles of greater diameter are used first.

A first penetration in accordance with the example of embodiment 2 was made.

Single channel supports of outer diameter 10 mm, inner diameter 6 mm and length 1200 mm made in the example of embodiment 2 are used. However, only the supports referenced 10/40/5 et 10/40/3 on which no deposit exists on the surface of the channels are used.

The second particles used are titanium oxide particles having a mean particle size of 0.1 μm. The powder is deflocculated using an adjuvant of the COATEX family. The suspension does not contain any organic binder and the powder concentration is less than 20 g/l. The values of these two parameters are intended to obtain very low viscosity.

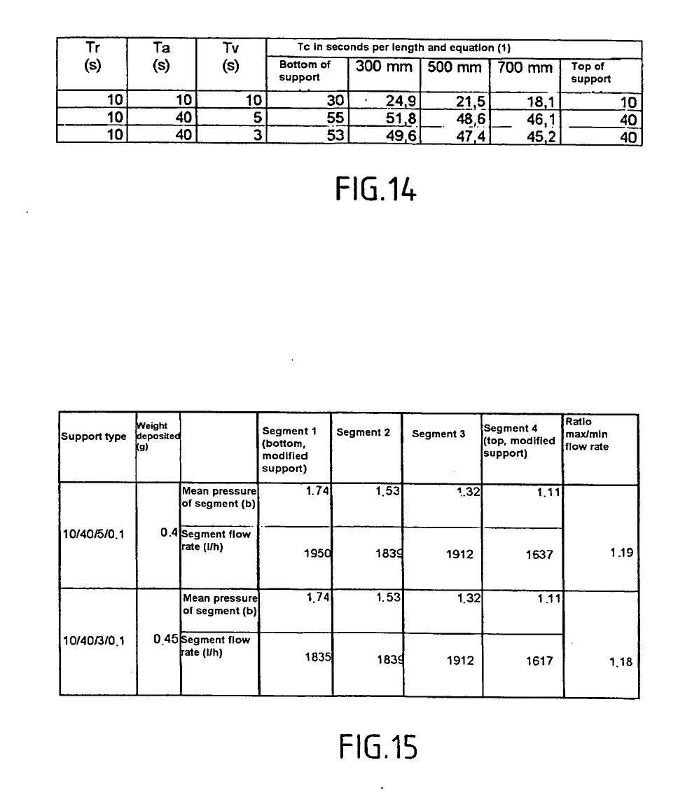

The experimental penetration conditions conducted with this second suspension are given in the table in FIG. 14. These conditions are identical to those in example 2 to avoid the formation of a deposit. As in example 1, three supports are made for each trio Tr/Ta/Tv. These modified supports are calcined at 900° C. then subjected to the same sampling and measurements as in the example of embodiment 2 above. The table in FIG. 15 gives the flow rate values measured on these modified supports. To distinguish them for the preceding example, the notation/O.A has been added to the reference of each modified support. It appears that the penetration of a fine powder inside a pore partly filled with large particles has major consequences on the flow rate of the segments since the values of these flow rates are the lowest in the series of examples of embodiment of the invention. Compared with the reference values in the table in FIG. 6, the values given in the table in FIG. 15 are approximately 3 or 4 times lower, demonstrating the efficacy of double penetration using two powders of very different particle size.

As in example 2, the high emptying speed promotes the homogeneity of flow rates. Penetration of the finest powder could not be determined since it is difficult to distinguish large size particles from small size particles after sintering. However, no deposit was observed on the inner surface 4 of support 2.

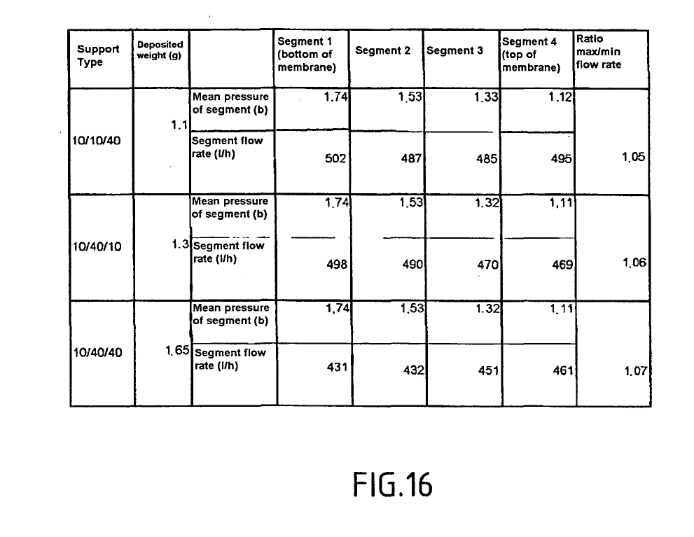

On the third modified support, a deposit was made enabling a separation layer to be obtained of mean pore diameter 0.2 μm. After sintering, this new membrane was tested and the values obtained are given in the table in FIG. 16. The flow rate values of the segments for each membrane are homogeneous. In addition, compared with the values given in the table in FIG. 8 obtained for the example in embodiment 1 in which a membrane of identical porosity was made, it is observed that the flow rate of the segments is considerably lower, by approximately a ratio of 2. This ratio shows an additional advantage of the invention since it enables very different flow rates to be obtained for one same membrane layer and a pre-modification identical support.

1. Membrane for tangential filtration of a fluid to be treated, said membrane comprising a porous support (2) delimiting at least one flow channel (3) for the fluid to be treated flowing in a given direction(f) between an inlet (6) and an outlet (7), the inner surface (4) of the porous support (2) which delimits channel (3) being coated with at least one separator layer (5) for the fluid to be treated, a fraction called a permeate passing through the separator layer (5) and the porous support (2), characterized in that the support has variable, partial pore-filling (c) extending from the inner surface (4) of support (2) on which the separator layer (5) is deposited, this said partial pore-filling, on a portion (8) of support (2) of a given constant thickness (e) extending from the inner surface (4) of support (2), creating a mean porosity gradient in the direction of flow of the fluid to be treated, the minimum mean porosity being located at the inlet(6) and the maximum mean porosity at the outlet (7).

2. Membrane as in claim 1, characterized in that the variable partial pore-filling (c) on portion (8) of support (2) of given thickness (e) extending from the inner surface (4) of support (2), creates a flux density gradient per unit of pressure in the direction of flow of the fluid to be treated, the minimum flux density per unit of pressure being located at the inlet (6) and the maximum flux density per unit of pressure at the outlet (7).

3. Membrane as in claim 1, characterized in that the mean porosity of the support (2) increases inside the support in a direction that is transverse to the direction of flow of the fluid to be treated, between the inner surface (4) and the outer surface (2₁) of support (2).

4. Membrane as in claim 1, characterized in that the variable, partial pore-filling (c) of portion (8) is made over a depth (p), from the inner surface (4) of the support (2), which decreases in the direction of flow (f) of the fluid to be treated between the inlet (6) and the outlet (7).

5. Membrane as in claim 1, characterized in that the variable partial pore-filling (c) of portion (8) is due to an increase in the mean pore diameter of portion (8) in the direction of flow (f) of the fluid to be treated between the inlet (6) and the outlet (7).

6. Membrane as in claim 1, characterized on that the variable, partial pore-filling (c) of portion (8) is obtained by the penetration, from inner surface (4) of support (2), of inorganic particles whose mean diameter is smaller than the mean pore diameter dp of the support (2).

7. Membrane as in claim 6, characterized in that the penetration of inorganic particles is followed by sintering.

8. Membrane as in claim 1, characterized in that portion (8) of constant thickness (e) has a mean porosity which increases in substantially continuous manner in the direction of flow (f) of the fluid to be treated, between inlet (6) and outlet (7), so as to obtain a substantially constant permeate flow rate along the length of the flow channel (3).

9. Membrane as in claim 1, characterized in that portion (8) of constant thickness (e) has a mean porosity which increases in plateaus (Pᵢ) in the direction of flow (f) of the fluid to be treated, between the inlet (6) and the outlet (7), the length of said plateaus taken in the direction of flow (f) preferably being substantially identical.

10. Method for fabricating a membrane for the tangential filtration of a fluid to be treated, comprising a porous support (2) delimiting at least one flow channel (3) for the fluid to be treated flowing in a given direction (f) between an inlet (6) and an outlet (7), the inner surface (4) of the porous support (2) which delimits the channel (3) being coated with at least one separator layer (5) for the fluid to be treated, characterized in that it comprises a step consisting of modifying the porous support (2) by the penetration, from the inner surface (4) of porous support (2) delimiting channel (3), of inorganic particles whose mean diameter is smaller than the mean pore diameter dp of the support (2), so that on a portion (8) of a given constant thickness (e) extending from the inner surface (4) of support (2), it is possible to obtain a mean porosity gradient in the direction of flow of the fluid to be treated, the minimum mean porosity being located at the inlet (6) and the maximum mean porosity at the outlet (7).

11. Method as in claim 10, characterized in that the step consisting of modifying the porous support (2) by penetration is followed by a sintering step.

12. Method as in claim 10 characterized in that the value of the mean porosity gradient of portion (8) is chosen in relation to the value of the pressure gradient of the fluid to be treated flowing in channel (3), in order to obtain a permeate flow rate that is substantially constant along the length of the flow channel (3).

13. Method as in claim 10, characterized in that the mean diameter of the inorganic particles lies between dp/100 and dp/2.

14. Method as in claim 10, characterized in that penetration is made so that the inorganic particles penetrate inside the pores of portion (8) over a depth (p), from the inner surface (4) of support (2) on which the separator layer (5) is deposited, which decreases in the direction of flow (f) of the fluid to be treated between the inlet (6) and the outlet (7).

15. Method as in claim 14, characterized in that it consists of ensuring the penetration of inorganic particles from the inner surface (4) of the porous support (2):
by arranging the porous support (2) vertically, the lower end of the support corresponding to the inlet (6) and the upper end of the support to the outlet (7),
by filling channel (3) with a deflocculated suspension of inorganic particles,
and by emptying channel (3) progressively, with a view to obtaining a contact time Tc, between the suspension of inorganic particles and the inner surface (4) of the support (3), which increases progressively in order to obtain a penetration depth (p), from the inner surface (4) of support (2), which decreases in the direction of flow (f) of the fluid to be treated between the inlet (6) and the outlet (7), i.e. between the lower end and the upper end of the porous support (2).

16. Method as in claim 15, characterized in that the mean porosity gradient on portion (8) of given constant thickness (e) is obtained by successive penetrations of a first series of inorganic particles whose mean diameter d₁, lies between dp/100 and dp/2, then of a second series of inorganic particles whose mean diameter d₂ lies between d₁/100 and d₁/2.

17. Method as in claim 10, characterized in that, simultaneously with penetration, organic particles are deposited on the inner surface (4) of the support, this deposit after sintering forming the separator layer (5).
